(19) United States
(12) Patent Application Publication
(10) Pub. No.: US 2025/0102897 A1
(43) Pub. Date: Mar. 27, 2025

(54) LENS APPARATUS AND IMAGE PICKUP APPARATUS

(71) Applicant: CANON KABUSHIKI KAISHA, Tokyo (JP)

(72) Inventors: Fumihiro SHINOBU, Tochigi (JP); Akira MIZUMA, Saitama (JP); Yuichi KOSAKA, Tochigi (JP); Shinichiro SAITO, Tochigi (JP)

(21) Appl. No.: 18/805,869

(22) Filed: Aug. 15, 2024

(30) Foreign Application Priority Data
Sep. 26, 2023 (JP) 2023-163021

(51) Int. Cl. G03B 35/10; G02B 15/14; G03B 5/00; H04N 13/236

(52) U.S. Cl. CPC G03B 35/10; G02B 15/143503; G02B 15/143507; G03B 5/00; H04N 13/236; G03B 2205/0046

(57) ABSTRACT

A stereoscopic optical system includes two optical systems arranged in parallel. Optical images corresponding to the two optical systems are formed on different areas in a single image sensor. Each of the two optical systems includes a plurality of lens units. A distance between adjacent lens units changes when a focal length changes in each of the two optical systems. One of the plurality of lens units is a movable lens unit. A predetermined inequality is satisfied.

### BACKGROUND

### Technical Field

One of the aspects of the embodiments relates to a stereoscopic optical system for three-dimensional imaging, and an image pickup apparatus having the same.

### Description of Related Art

Stereoscopic optical systems are demanded which can provide stereoscopically viewable images for virtual reality (VR) and other applications. Japanese Patent Laid-Open No. 2020-008629 discloses a stereoscopic optical system that includes two ultra-wide-angle lenses arranged in parallel. Japanese Patent Laid-Open No. 2013-057738 discloses an image pickup apparatus that includes two zoom lenses having variable focal lengths and arranged in parallel.

The stereoscopic optical system disclosed in Japanese Patent Laid-Open No. 2020-008629 allows for three-dimensional imaging using a full-circle fisheye lens, but has difficulty in making the focal length variable. The image pickup apparatus disclosed in Japanese Patent Laid-Open No. 2013-057738 that moves a plurality of movable units to change the focal length causes non-negligible positional errors (moving amounts) of the movable units between the two zoom lenses, that is, a non-negligible focal length difference, and may not be able to obtain a proper stereoscopic effect during imaging.

### SUMMARY

A stereoscopic optical system according to one aspect of the disclosure includes two optical systems arranged in parallel. Optical images corresponding to the two optical systems are formed on different areas in a single image sensor. Each of the two optical systems includes a plurality of lens units. A distance between adjacent lens units changes when a focal length changes in each of the two optical systems. One of the plurality of lens units is a movable lens unit. A focal length is changed by moving the movable lens unit. The following inequality is satisfied:

$$0.5 \leq Din / fw \leq 50.0$$

where Din is a distance between optical axes of lenses closest to an object in the two optical systems, and fw is a focal length of each of the two optical systems at a wide-angle end. An image pickup apparatus having the above stereoscopic optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a lens apparatus and stereoscopic optical system according to each example.

FIG. 2 is a sectional view of a stereoscopic optical system according to Example 1.

FIGS. 3A and 3B are aberration diagrams of the stereoscopic optical system according to Example 1.

FIG. 4 is a sectional view of a stereoscopic optical system according to Example 2.

FIGS. 5A and 5B are aberration diagrams of the stereoscopic optical system according to Example 2.

FIG. 6 is a sectional view of a stereoscopic optical system according to Example 3.

FIGS. 7A and 7B are aberration diagrams of the stereoscopic optical system according to Example 3.

FIG. 8 is a sectional view of a stereoscopic optical system according to Example 4.

FIGS. 9A and 9B are aberration diagrams of the stereoscopic optical system according to Example 4.

FIG. 10 is a sectional view of a stereoscopic optical system according to Example 5.

FIGS. 11A and 11B are aberration diagrams of the stereoscopic optical system according to Example 5.

FIG. 12 is a sectional view of a stereoscopic optical system according to Example 6.

FIGS. 13A and 13B are aberration diagrams of the stereoscopic optical system according to Example 6.

FIG. 14 is a schematic diagram of an image pickup apparatus having the stereoscopic optical system according to any one of Examples 1 to 6.

FIG. 15 illustrates optical images formed on an image sensor in each example.

### DESCRIPTION OF THE EMBODIMENTS

Referring now to the accompanying drawings, a description will be given of embodiments according to the disclosure.

FIG. 1 illustrates a section of a lens apparatus 100 having a stereoscopic optical system according to each example described later, viewed from the top. FIG. 1 also illustrates a section of an image pickup apparatus 110 to which the lens apparatus 100 as an interchangeable lens is detachably attached. The image pickup apparatus 110 includes a digital video camera, a digital still camera, a broadcasting camera, a surveillance camera, and a film-based camera. The image pickup apparatus 110 may also be a camera for a mobile terminal such as a smartphone or a tablet. In FIG. 1, a left side is an object side, a right side is an image side, an upper side is a right side and a lower side is a left side in the horizontal direction.

The lens apparatus 100 holds a stereoscopic optical system consisting of two optical systems 101 and 102 arranged in parallel on the left and right sides in a housing. The two optical systems 101 and 102 have the same configurations, and form a right object image and a left object image as two optical images in different areas on a (single) imaging surface of a single image sensor 111 disposed on an image plane IP.

FIG. 15 illustrates right and left object images (image circles) 121 and 122 formed on the imaging surface of the image sensor 111 by the stereoscopic optical system according to each example. The right object image 121 is formed in a right half area (the left side in FIG. 15) and the left object image 122 is formed in a left half area (the right side in FIG. 15) in the longitudinal direction of the imaging surface. Photoelectrically converting (capturing) these two object images using the image sensor 111 can provide two captured images (i.e., right-eye image and left-eye image) that have parallax and are stereoscopically viewable. These right-eye and left-eye images are displayed on a display element such as a liquid crystal panel or an organic EL panel in a stereoscopic display apparatus such as VR goggles or a head mount display. An observer can recognize a three-dimensional image by viewing the right-eye image with the right eye and the left-eye image with the left eye, respectively.

A film surface of a film-based camera serving as an image pickup apparatus may be disposed as a single imaging surface on the image plane IP.

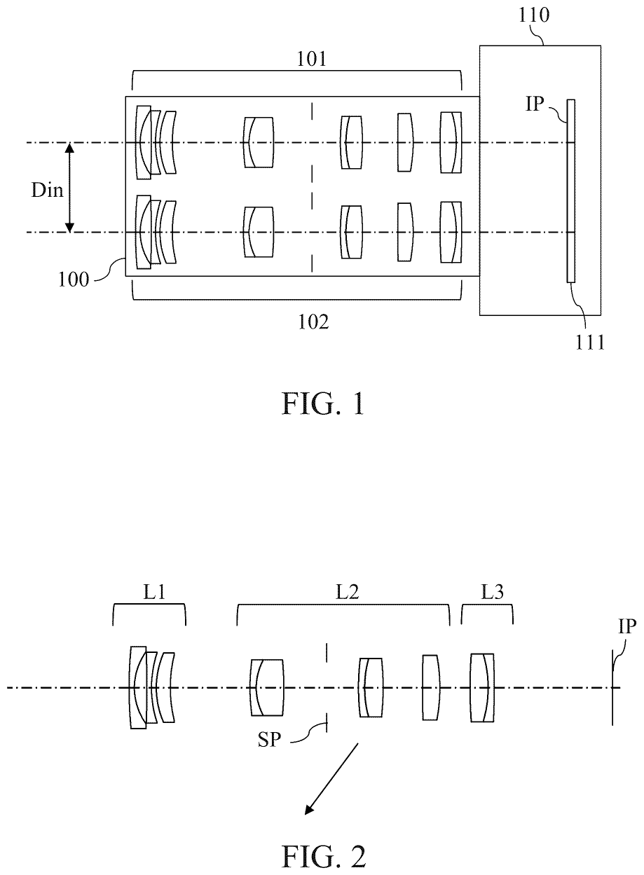

FIGS. 2, 4, 6, 8, 10, and 12 illustrate sections of one of the two optical systems in the stereoscopic optical systems according to Examples 1 to 6 at the wide-angle end. In these figures, the left side is the object side, and the right side is the image side.

Each of the two optical systems 101 and 102 consists of, in order from the object side to the image side, a first lens unit L1, a second lens unit L2, and a third lens unit L3. Each optical system is a zoom lens with a variable focal length, and the focal length is changed by moving the second lens unit L2 as a single movable lens unit without moving the first and third lens units L1 and L3. An arrow in each figure indicates a moving locus of the second lens unit L2 toward the object side when the focal length changes from the wide-angle end to the telephoto end.

The lens unit is a group of one or more lenses that integrally move when the focal length is changed (during zooming) between the wide-angle end and the telephoto end. That is, when the focal length is changed, a distance between adjacent lens units changes. The wide-angle end and the telephoto end respectively indicate the maximum angle of view (shortest focal length) and the minimum angle of view (longest focal length) when the movable lens unit is located at both ends of a mechanically or controlled movable range on the optical axis.

SP in each figure represents an aperture stop, which adjusts a light amount that passes through each optical system and reaches the image plane IP.

Each of the two optical systems 101 and 102 according to each example consists of three lens units, i.e., the first to third lens units L1 to L3, but each optical system may consist of two lens units. Even in this case, a single movable lens unit may be moved to change the focal length.

A description will now be given of a characteristic configuration of the stereoscopic optical system according to each example. In a stereoscopic optical system capable of three-dimensional imaging, an observer observes captured images (right-eye and left-eye images) obtained by three-dimensional imaging through a display apparatus such as VR goggles. Since humans are sensitive to an image shift viewed by the left and right eyes, a relative error of the two optical systems in the stereoscopic optical system is to be reduced. In order to make the focal length of the two optical systems variable under such conditions, it is effective to reduce the number of movable lens units in each optical system. Moreover, a driving member such as a cam ring is to move the movable lens unit. In a case where a driving member is provided for each of the two optical systems, a base length increases, which is a distance between the optical axes of the two optical systems, and it becomes difficult to accommodate the two optical images formed by the two optical systems on the imaging surface of a single image sensor. Thus, in the two optical systems 101 and 102 according to each example, the focal length is changed by moving only the second lens unit L2, which is one movable lens unit.

The optical systems 101 and 102 according to each example may have the following configuration.

The two second lens units in the two optical systems 101 and 102 may be integrally moved by a single actuator. Thereby, no driving member is necessary such as a cam ring for each optical system, and both a compact stereoscopic optical system and a sufficient base length can be secured.

Each optical system may adjust focusing by moving the second lens unit L2 as the movable lens unit as described above. A compact stereoscopic optical system is to reduce the number of lens units and lenses as small as possible. A lens unit disposed close to an object or the image plane and selected as the movable lens unit fluctuates the optical performance with a change in focal length of the optical system, e.g., significantly changes particularly the spherical aberration and the curvature of field.

The movable lens unit may include an aperture stop SP. In a compact stereoscopic optical system, the aperture stop and the movable lens unit that are separated from each other are likely to fluctuate the optical performance with the change in focal length, e.g., to increase particularly the spherical aberration and the curvature of field.

Each optical system may have a first lens unit L1 having negative refractive power, a second lens unit having positive refractive power, and a third lens unit having positive or negative refractive power. Thereby, curvature of field and astigmatism can be satisfactorily corrected at the wide-angle end and the telephoto end.

The first lens unit L1 may include, in order from the object side to the image side, a first lens having negative refractive power and a second lens having negative refractive power. Thereby, curvature of field, astigmatism, and distortion can be satisfactorily corrected while an angle of view at the wide-angle end of each optical system can be widened.

Focusing may be performed by entirely moving the two optical systems 101 and 102. As described above, a stereoscopic optical system is to reduce a relative error between the two optical systems. In a case where focusing is performed by moving some lens units in the two optical systems, the relative error is likely to occur. During focusing, the entire optical systems 101 and 102 may be integrally moved. Thereby, the relative error can be more effectively reduced. In order to reduce the size of the lens apparatus, the optical systems 101 and 102 may be moved with a single actuator.

The stereoscopic optical system according to each example may satisfy at least one of the following inequalities (1) to (14):

$$0.3 \leq Din / f t \leq 30. \qquad ( 1 )$$

$$0.5 \leq Din / fw \leq 50. \qquad ( 2 )$$

$$2. \leq TL / f t \leq 20. \qquad ( 3 )$$

$$3. \leq TL / fw \leq 50. \qquad ( 4 )$$

$$- 5. \leq f 1 / fw \leq - 0.5 \qquad ( 5 )$$

$$0.5 \leq f 2 / fw \leq 10. \qquad ( 6 )$$

$$- 0.5 \leq fw / f 3 \leq 0.2 \qquad ( 7 )$$

$$2. \leq PeW / fw \leq 50. \qquad ( 8 )$$

$$2. \leq PeT / f t \leq 50. \qquad ( 9 )$$

$$0.2 \leq fm / f t \leq 5. \qquad ( 10 )$$

$$( 0.2 \leq f 2 / f t \leq 5. )$$

$$0 < Dm / f t \leq 5. \qquad ( 11 )$$

$$( 0 < D 2 / f t \leq 5. )$$

$$0.2 \leq Lb / fb \leq 10. \qquad ( 12 )$$

$$2. \leq TDL / fw \leq 50. \qquad ( 13 )$$

$$0.2 \leq BF / fw \leq 5. \qquad ( 14 )$$

In inequalities (1) to (14), Din is a distance between the optical axes of the lenses closest to the object of the two optical systems 101 and 102 (base length), ft is a focal length of each optical system at the telephoto end, and fw is a focal length of each optical system at the wide-angle end. TL is a distance on the optical axis from a surface closest to the object of each optical system to the image plane IP (overall optical length), f1 is a focal length of the first lens unit L1, f2 is a focal length of the second lens unit L2, and f3 is a focal length of the third lens unit L3. PeW is an exit pupil distance of each optical system at the wide-angle end, and PeT is an exit pupil distance at the telephoto end. The exit pupil distance is a distance on the optical axis from the image plane IP to the exit pupil located at the image position of the aperture stop SP.

fm (f2) is a focal length of the movable lens unit (second lens unit L2), and Dm (D2) is a moving amount of the movable lens unit (second lens unit L2) from the wide-angle end to the telephoto end. The moving amount is set positive when the movable lens unit is closer to the object at the telephoto end than at the wide-angle end.

fb is a combined focal length of a portion on the image side of the aperture stop SP of each optical system at the wide-angle end, Lb is a distance on the optical axis from the aperture stop SP to the image plane IP at the wide-angle end, and TDL is a distance on the optical axis from a surface closest to the object to a surface closest to the image plane in each optical system. BF is a back focus of each optical system at the wide-angle end. The back focus is a distance on the optical axis from the surface closest to the image plane of the optical system to the image plane IP.

Inequality (1) defines a proper relationship between the base length Din of the two optical systems 101 and 102 and the focal length ft at the telephoto end. In a case where Din/ft becomes lower than the lower limit of inequality (1), the base length reduces, and the two optical systems 101 and 102 interfere with each other. In a case where Din/ft becomes higher than the upper limit of inequality (1), a parallax image that allows excellent stereoscopic viewing cannot be obtained.

Inequality (2) defines a proper relationship between the base length Din of the two optical systems 101 and 102 and the focal length fw at the wide-angle end. In a case where Din/fw becomes lower than the lower limit of inequality (2), the base length reduces, and the two optical systems 101 and 102 interfere with each other. In a case where Din/fw becomes higher than the upper limit of inequality (2), a parallax image that allows excellent stereoscopic viewing cannot be obtained.

Inequality (3) defines a proper relationship between the overall optical length TL of each optical system and the focal length ft at the telephoto end in order to reduce the size of the entire stereoscopic optical system without interference between the two optical systems 101 and 102 at the telephoto end. In a case where TL/ft becomes lower than the lower limit of inequality (3), an effective diameter of an object-side lens or image-side lens of each optical system increases, and the two optical systems 101 and 102 interfere with each other. In a case where TL/ft becomes higher than the upper limit of inequality (3), the size of the entire stereoscopic optical system increases.

Inequality (4) defines a proper relationship between the overall optical length TL of each optical system and the focal length fw at the wide-angle end in order to reduce the size of the entire stereoscopic optical system without interference between the two optical systems 101 and 102 at the wide-angle end. In a case where TL/fw becomes lower than the lower limit of inequality (4), the effective diameter of the object-side lens and image-side lens of each optical system increases, and the two optical systems 101 and 102 interfere with each other. In a case where TL/fw becomes higher than the upper limit of inequality (4), the size of the entire stereoscopic optical system increases.

Inequality (5) defines a proper relationship between the focal length f1 of the first lens unit L1 and the focal length fw of each optical system at the wide-angle end. In a case where f1/fw becomes lower than the lower limit of inequality (5), the power of the first lens unit L1 reduces, and it becomes difficult to make each optical system wide-angle. In a case where f1/fw becomes higher than the upper limit of inequality (5), the power of the first lens unit L1 increases, and it becomes difficult to correct the curvature of field, astigmatism, and distortion.

Inequality (6) defines a proper relationship between the focal length f2 of the second lens unit L2 and the focal length fw of each optical system at the wide-angle end. In a case where f2/fw becomes lower than the lower limit of inequality (6), the magnification of the change in focal length from the wide-angle end to the telephoto end reduces. In a case where f2/fw becomes higher than the upper limit of inequality (6), the performance of the optical system varies with the change in focal length, and in particular the variations in spherical aberration and curvature of field increase.

Inequality (7) defines a proper relationship between the focal length f3 of the third lens unit L3 and the focal length fw of each optical system at the wide-angle end. In a case where fw/f3 becomes lower than the lower limit of inequality (7), the back focus of each optical system reduces, and it becomes difficult to dispose the third lens unit L3. In a case where fw/f3 becomes higher than the upper limit of inequality (7), the diameter of the third lens unit increases and the two optical systems 101 and 102 interfere with each other.

Inequality (8) defines a proper relationship between the exit pupil distance PeW of each optical system at the wide-angle end and the focal length fw at the wide-angle end. In a case where PeW/fw becomes lower than the lower limit of inequality (8), the back focus of each optical system reduces, and it becomes difficult to dispose the third lens unit L3. In a case where PeW/fw becomes higher than the upper limit of inequality (8), the diameter of the entire optical system increases and the two optical systems 101 and 102 interfere with each other.

Inequality (9) defines a proper relationship between the exit pupil distance PeT of each optical system at the telephoto end and the focal length ft at the telephoto end. In a case where PeT/ft becomes lower than the lower limit of inequality (9), the back focus of each optical system reduces, and it becomes difficult to dispose the third lens unit L3. In a case where PeT/ft becomes higher than the upper limit of inequality (9), the diameter of each optical system increases, and the two optical systems 101 and 102 interfere with each other.

Inequality (10) defines a proper relationship between the focal length fm of the movable lens unit and the focal length ft of each optical system at the telephoto end. In a case where fm/ft becomes lower than the lower limit of inequality (10), the power of the second lens unit L2 increases, the performance varies with changes in the focal length of the optical system, and in particular, the curvature of field, astigmatism, and lateral aberration tend to increase. In a case where fm/ft becomes higher than the upper limit of inequality (10), the power of the second lens unit L2 reduces, and the magnification of the change in focal length from the wide-angle end to the telephoto end reduces.

Inequality (11) defines a proper relationship between the moving amount Dm of the movable lens unit from the wide-angle end to the telephoto end and the focal length ft of each optical system at the telephoto end. In a case where Dm/ft becomes lower than the lower limit of inequality (11), the power of the second lens unit L2 increases, and the performance varies with the change in focal length of the optical system, and in particular, the curvature of field, astigmatism, and lateral aberration tend to increase. In a case where Dm/ft becomes higher than the upper limit of inequality (11), the moving amount of the second lens unit L2 increases, and the size of each optical system increases.

Inequality (12) defines a proper relationship between the combined focal length fb of the portion of each optical system on the image side of the aperture stop SP at the wide-angle end and the distance Lb from the aperture stop SP to the image plane IP at the wide-angle end. In a case where Lb/fb becomes lower than the lower limit of inequality (12), the back focus of each optical system reduces, and it becomes difficult to dispose the third lens unit L3. In a case where Lb/fb becomes higher than the upper limit of inequality (12), the overall diameter of each optical system increases, and the two optical systems 101 and 102 interfere with each other.

Inequality (13) defines a proper relationship between the distance TDL from the surface closest to the object to the surface closest to the image plane of each optical system and the focal length fw at the wide-angle end. In a case where TDL/fw becomes lower than the lower limit of inequality (13), it becomes difficult to increase the focal length of each optical system on the telephoto side. In a case where TDL/fw becomes higher than the upper limit of inequality (13), the size of each optical system wholly increases.

Inequality (14) defines a proper relationship between the back focus BF of each optical system and the focal length fw at the wide-angle end. In a case where BF/fw becomes lower than the lower limit of inequality (14), the back focus reduces, and it becomes difficult to dispose the third lens unit L3. In a case where BF/fw becomes higher than the upper limit of inequality (14), the size of each optical system wholly increases.

Inequalities (1) to (14) may be replaced with inequalities (1a) to (14a) below:

$$0.3 \leq Din / f t \leq 20. \qquad ( 1 a )$$

$$0.5 \leq Din / fw \leq 25. \qquad ( 2 a )$$

$$2. \leq TL / f t \leq 15. \qquad ( 3 a )$$

$$3. \leq TL / fw \leq 30. \qquad ( 4 a )$$

$$- 3. \leq f 1 / fw \leq - 0.5 \qquad ( 5 a )$$

$$0.5 \leq f 2 / fw \leq 7. \qquad ( 6 a )$$

$$- 0.4 \leq fw / f 3 \leq 0.2 \qquad ( 7 a )$$

$$2. \leq PeW / fw \leq 40. \qquad ( 8 a )$$

$$2. \leq PeT / f t \leq 40. \qquad ( 9 a )$$

$$0.2 \leq fm / f t \leq 4. \qquad ( 10 a )$$

$$0.2 \leq Dm / f t \leq 4. \qquad ( 11 a )$$

$$0.2 \leq Lb / fb \leq 5. \qquad ( 12 a )$$

$$2. \leq TDL / fw \leq 30. \qquad ( 13 a )$$

$$0.2 \leq BF / fw \leq 3. \qquad ( 14 a )$$

Inequalities (1) to (14) may be replaced with inequalities (1b) to (14b) below:

$$0.4 \leq Din / f t \leq 10. \qquad ( 1 b )$$

$$0.7 \leq Din / fw \leq 150 \qquad ( 2 b )$$

$$2. \leq TL / f t \leq 10. \qquad ( 3 b )$$

$$5. \leq TL / fw \leq 20. \qquad ( 4 b )$$

$$- 3. \leq f 1 / fw \leq - 0.7 \qquad ( 5 b )$$

$$1. \leq f 2 / fw \leq 5. \qquad ( 6 b )$$

$$- 0.3 \leq f w / f 3 \leq 02 \qquad ( 7 b )$$

$$2. \leq PeW / fw \leq 30. \qquad ( 8 b )$$

$$2. \leq PeT / f t \leq 30. \qquad ( 9 b )$$

$$0.5 \leq fm / f t \leq 3. \qquad ( 10 b )$$

$$0.5 \leq Dm / f t \leq 3. \qquad ( 11 b )$$

$$0.5 \leq Lb / fb \leq 4. \qquad ( 12 b )$$

$$3. \leq TDL / fw \leq 20. \qquad ( 13 b )$$

$$0.5 \leq BF / fw \leq 2. 0 \qquad ( 14 b )$$

A detailed description will now be given of the configurations of the optical systems 101 and 102 according to each example. Numerical examples 1 to 6 corresponding to Examples 1 to 6 follow the description of Example 6. Details of numerical examples will be described later.

### Example 1

An optical system according to Example 1 (numerical example 1) illustrated in FIG. 2 includes a first lens unit L1 having negative refractive power, a second lens unit L2 having positive refractive power, and a third lens unit L3 having negative refractive power.

In the optical system according to this example, only the second lens unit L2 is moved as a movable lens unit to change the focal length. In each optical system, the optical power arrangement is adjusted so that the position of the image plane IP does not change even if the second lens unit L2 moves.

The optical system according to this example performs focusing by moving the entire optical system.

### Example 2

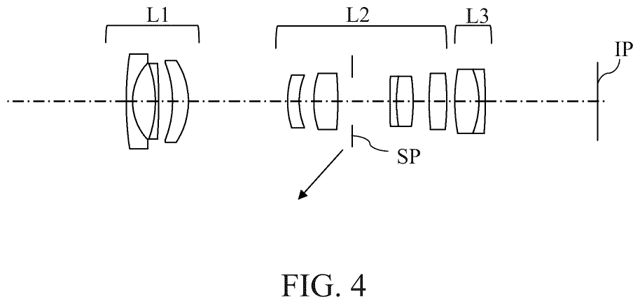

An optical system according to Example 2 (numerical example 2) illustrated in FIG. 4 includes a first lens unit L1 having negative refractive power, a second lens unit L2 having positive refractive power, and a third lens unit L3 having positive refractive power, and moves only the second lens unit L2 to change the focal length. Since the third lens unit L3 has positive refractive power, a variable range of the focal length is expanded to the wide-angle side in comparison with Example 1.

### Example 3

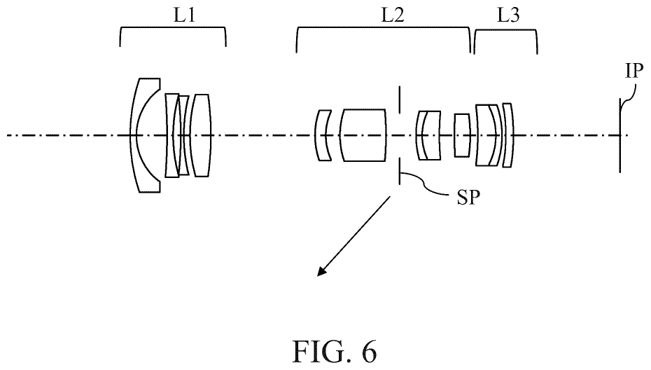

An optical system according to Example 3 (numerical example 3) illustrated in FIG. 6 includes a first lens unit L1 having negative refractive power, a second lens unit L2 having positive refractive power, and a third lens unit L3 having positive refractive power, similarly to Example 2, and changes a focal length by moving only the second lens unit L2.

In this example, a variable range of the focal length is expanded to the wide-angle side and the telephoto side in comparison with Example 1 by including an aspheric lens. The effective diameter and the base length of the optical system are larger than those of Example 2 due to the wide-angle configuration.

### Example 4

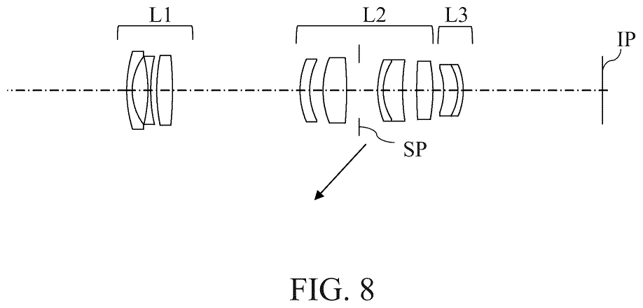

An optical system according to Example 4 (numerical example 4) illustrated in FIG. 8 includes a first lens unit L1 having negative refractive power, a second lens unit L2 having positive refractive power, and a third lens unit L3 having negative refractive power, similarly to Example 1, and changes a focal length by moving only the second lens unit L2.

The optical system according to this example has a variable range of the focal length shifted to the telephoto side relative to that of Example 1. In addition, using an proper power arrangement increases the magnification of the change in focal length from the wide-angle end to the telephoto end and suppresses the effective diameter of the optical system.

### Example 5

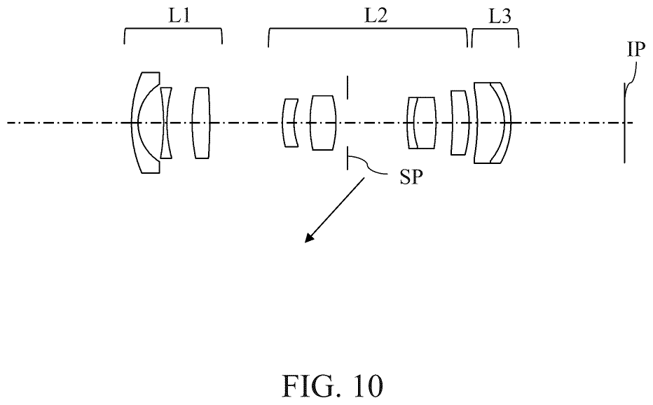

An optical system according to Example 5 (numerical example 5) illustrated in FIG. 10 includes a first lens unit L1 having negative refractive power, a second lens unit L2 having positive refractive power, and a third lens unit L3 having positive refractive power, similarly to Examples 2 and 3, and changes a focal length by moving only the second lens unit L2.

The optical system according to this example is made even wider-angle than that of Example 3.

### Example 6

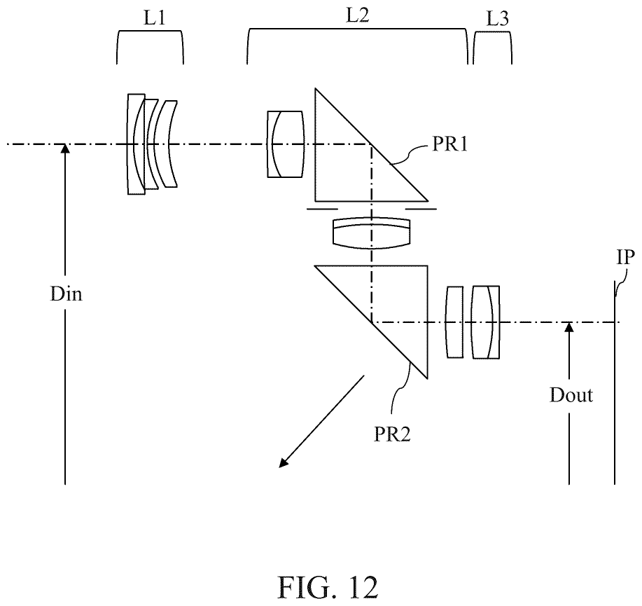

An optical system according to Example 6 illustrated in FIG. 12 includes a first lens unit L1 having negative refractive power, a second lens unit L2 having positive refractive power, and a third lens unit L3 having negative refractive power, similarly to Examples 1 and 4, and changes a focal length by moving only the second lens unit L2.

The optical systems according to Examples 1 to 5 are coaxial optical systems whose optical axes extend straight from the object side to the image side, and therefore a distance between the optical axes of the lenses closest to the image plane is also Din. On the other hand, the optical system according to this example is a bending optical system that bends the optical axis (optical path) twice.

More specifically, two reflective prisms PR1 and PR2 are disposed in the second lens unit L2 to bend the optical path by 90° each. This configuration secures the base length Din that is longer than that in Examples 1 to 5, and can acquire parallax images that present a stronger stereoscopic viewing feeling. Moreover, the distance between the optical axes of the lenses closest to the image plane is set to Dout, which is smaller than Din, and two optical images formed by the two optical systems can be accommodated on the imaging surface of a single image sensor 111.

The stereoscopic optical system having the optical systems 101 and 102 according to each example may be used for an image pickup apparatus that has a function of correcting various aberrations such as distortion and lateral chromatic aberration by image processing.

Numerical examples 1 to 6 will be illustrated below. In each numerical example, a surface number m indicates the order of a surface counted from the object side. r (mm) represents a radius of curvature of an m-th surface, and d (mm) represents a distance (air gap) on the optical axis between m-th and (m+1)th surfaces. nd represents a refractive index for the d-line of the optical material between the m-th and (m+1)-th surfaces, and vd represents an Abbe number of the optical member based on the d-line. The Abbe number vd based on the d-line is expressed as follows:

$$ν d = ( Nd - 1 ) / ( NF - NC )$$

where Nd, NF, and NC are refractive indices for the d-line (587.6 nm), F-line (486.1 nm), and C-line (656.3 nm) in the Fraunhofer lines, respectively. The effective diameter is a radius (mm) of an area of the m-th surface through which light rays that contribute to imaging pass.

In each numerical example, all of d, focal length (mm), F-number (Fno), and half angle of view (°) are values in a case where the optical system according to each example is in an in-focus state on an object at infinity. Aback focus (BF) (mm) has been described above. The overall lens length (mm) corresponds to the overall optical length described above.

An asterisk * added to the right side of the surface number means that the optical surface is aspheric. The aspheric shape is expressed as follows:

$$x = ( {h}^{2} / R ) / [ 1 + {\{ 1 - ( 1 + K ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12}$$

where x is a displacement amount from a surface vertex in the optical axis direction, h is a height from the optical axis in a direction orthogonal to the optical axis, R is a paraxial radius of curvature, K is a conic constant, and A4, A6, A8, A10, and A12 are aspheric coefficients of each order. “e±XX” in each of an aspheric coefficient and a conic constant means “×10^{±XX}.” WIDE and TELE represent a wide-angle end, and a telephoto end, respectively.

Table 1 summarizes the numerical values relating to inequalities (1) to (14) in each numerical example. Each numerical example satisfies all of inequalities (1) to (14).

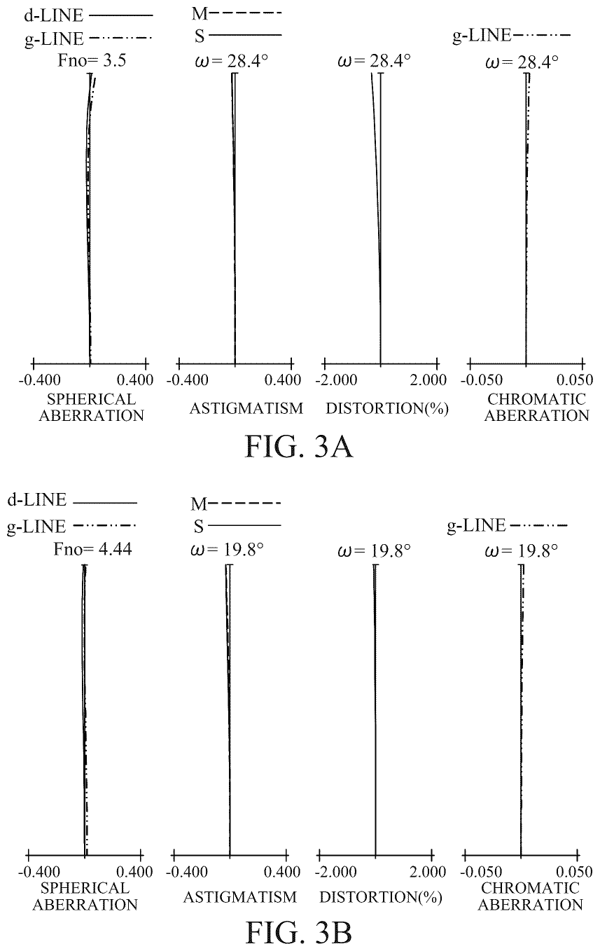

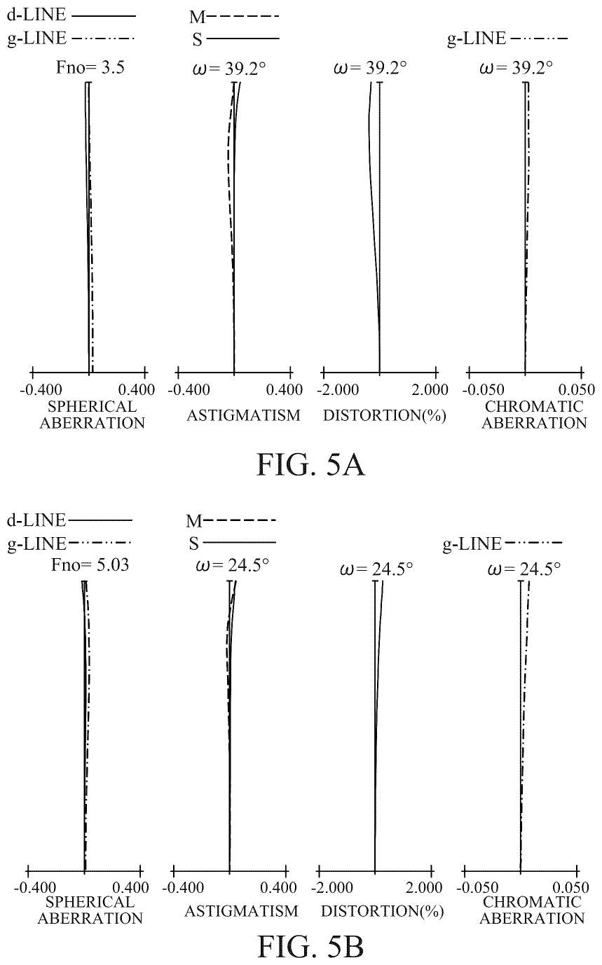

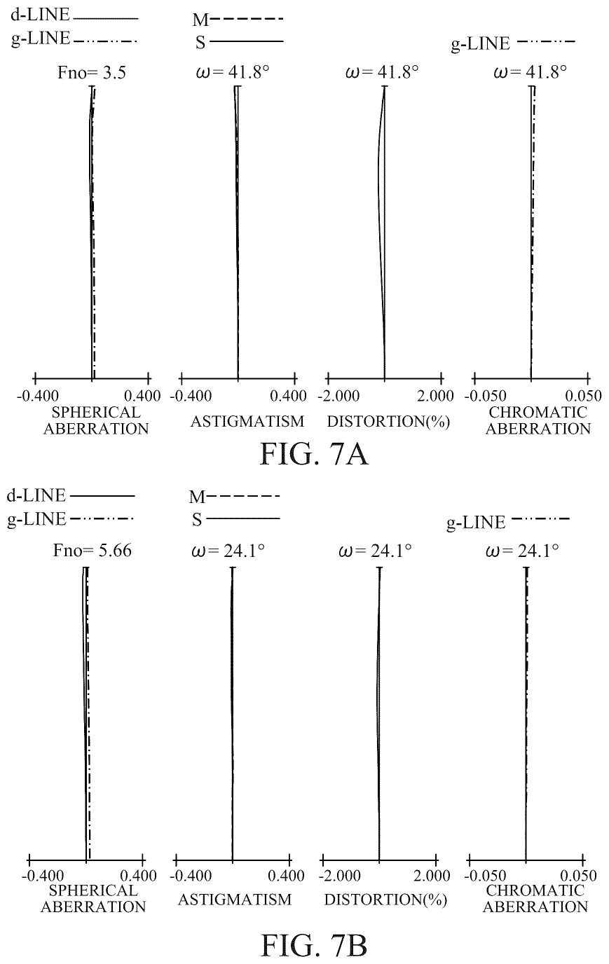

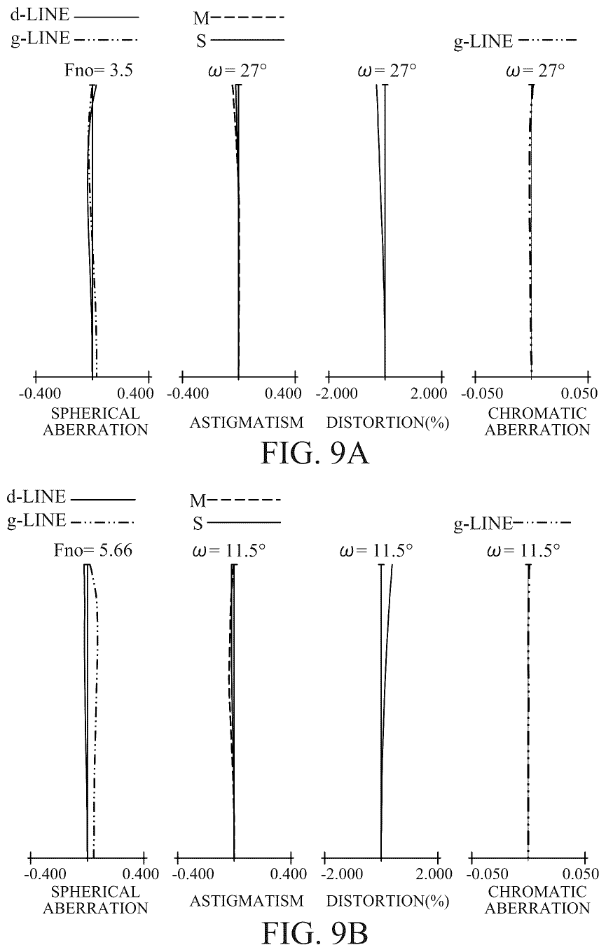

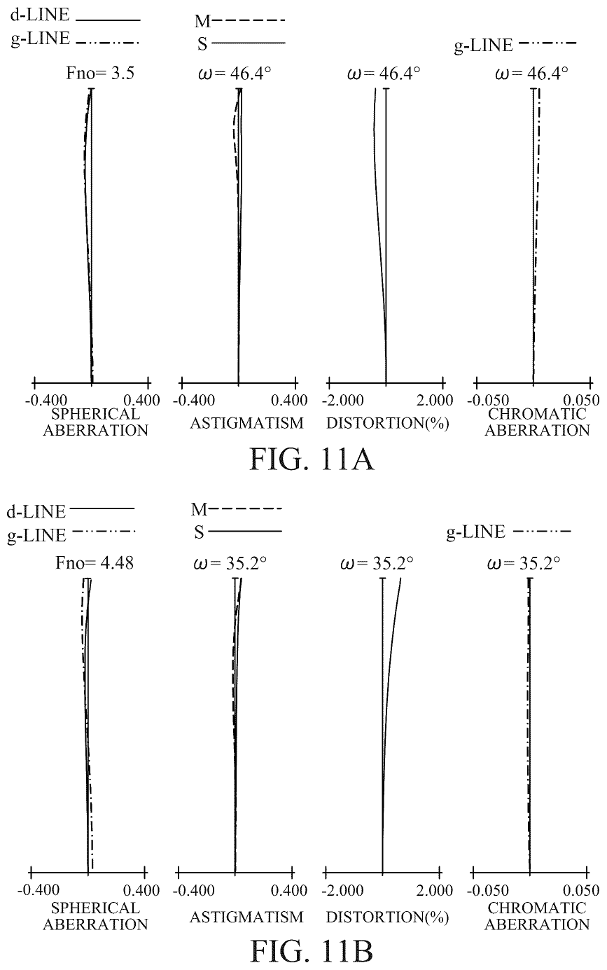

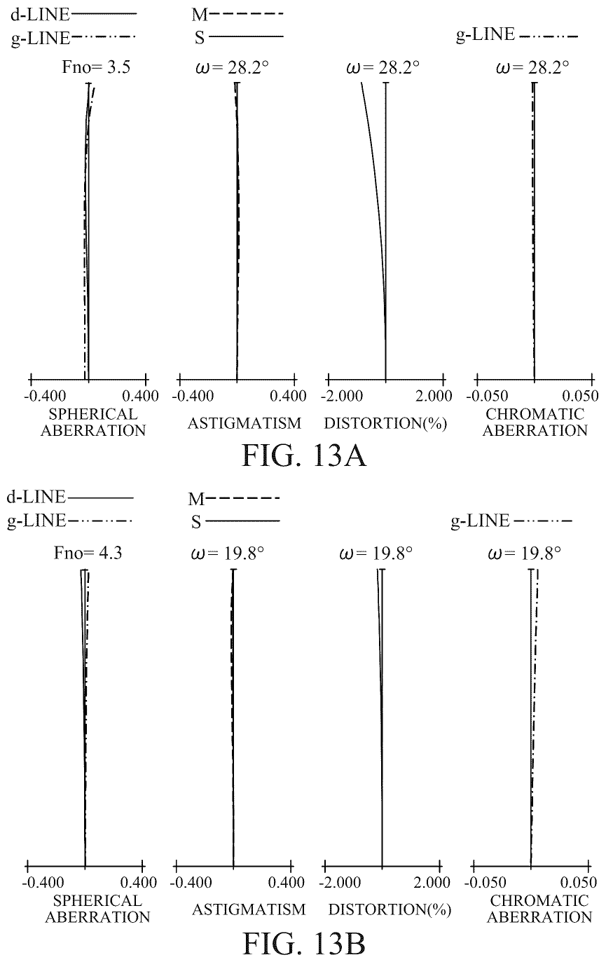

FIGS. 3A, 5A, 7A, 9A, 11A, and 13A respectively illustrate longitudinal aberrations (spherical aberration, astigmatism, distortion, and chromatic aberration) of the optical systems according to numerical examples 1 to 6 at the wide-angle end in an in-focus state on an object at infinity. FIGS. 3B, 5B, 7B, 9B, 11B, and 13B respectively illustrate longitudinal aberrations (spherical aberration, astigmatism, distortion, and chromatic aberration) of the optical systems according to numerical examples 1 to 6 at the telephoto end in an in-focus state on an object at infinity. In the spherical aberration diagram, Fno indicates the F-number. A solid line indicates a spherical aberration amount for the d-line (wavelength 587.6 nm), and an alternate long and short dash line indicates a spherical aberration amount for the g-line (wavelength 435.8 nm). In the astigmatism diagram, a solid line S indicates an astigmatism amount on a sagittal image plane, and a dashed line M indicates an astigmatism amount on a meridional image plane. The distortion diagram illustrates a distortion amount for the d-line. The chromatic aberration diagram illustrates a lateral chromatic aberration amount for the g-line. ω represents a half angle of view (°).

### Numerical Example 1

UNIT: mm
SURFACE DATA

| Surface No. | r | d | nd | vd | Effective Diameter |
|---|---|---|---|---|---|
| 1 | 54.702 | 0.70 | 1.80440 | 39.6 | 9.57 |
| 2 | 8.124 | 1.60 | | | 8.41 |
| 3 | −117.593 | 0.60 | 1.60562 | 43.7 | 8.29 |
| 4 | 14.681 | 0.63 | | | 8.07 |
| 5 | 11.366 | 1.80 | 1.80000 | 29.8 | 8.12 |
| 6 | 18.121 | (Variable) | | | 7.68 |
| 7 | 27.529 | 0.80 | 1.91082 | 35.2 | 6.24 |
| 8 | 7.657 | 3.54 | 1.80100 | 35.0 | 6.28 |
| 9 | −36.508 | 5.52 | | | 6.53 |
| 10 (SP) | ∞ | 4.10 | | | 6.67 |
| 11 | 31.952 | 0.80 | 2.00069 | 25.5 | 6.77 |
| 12 | 13.980 | 0.00 | 1.49700 | 81.5 | 6.67 |
| 13 | 13.980 | 2.38 | 1.49700 | 81.5 | 6.67 |
| 14 | −37.551 | 5.08 | | | 6.74 |
| 15 | 134.159 | 2.23 | 1.88300 | 40.8 | 7.27 |
| 16 | −22.241 | (Variable) | | | 7.60 |
| 17 | 63.573 | 2.32 | 1.49700 | 81.5 | 7.74 |
| 18 | −15.677 | 0.80 | 2.00069 | 25.5 | 7.70 |
| 19 | −81.180 | (Variable) | | | 7.84 |
| Image Plane | ∞ | | | | |

VARIOUS DATA

| ZOOM RATIO 1.50 | WIDE | TELE |
|---|---|---|
| Focal Length | 8.97 | 13.45 |
| Fno | 3.50 | 4.44 |
| Half Angle of View (°) | 28.40 | 19.83 |
| Image Height | 4.85 | 4.85 |
| Overall Lens Length | 62.24 | 62.24 |
| BF | 15.21 | 15.21 |
| d6 | 10.26 | 2.72 |
| d16 | 3.89 | 11.43 |
| d19 | 15.21 | 15.21 |
| Entrance Pupil Position | 7.70 | 6.91 |
| Exit Pupil Position | −24.96 | −28.51 |
| Front Principal-Point Position | 14.66 | 16.22 |
| Rear Principal-Point Position | 6.25 | 1.76 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −9.35 | 5.32 | 1.01 | −2.78 |
| 2 | 7 | 18.48 | 24.44 | 18.72 | −14.71 |
| 3 | 17 | −86.01 | 3.12 | 2.20 | 0.22 |

### Numerical Example 2

UNIT: mm
SURFACE DATA

| Surface No. | r | d | nd | vd | Effective Diameter |
|---|---|---|---|---|---|
| 1 | 41.949 | 0.80 | 2.00100 | 29.1 | 10.63 |
| 2 | 7.086 | 2.83 | | | 8.71 |
| 3 | −13.502 | 0.40 | 2.00100 | 29.1 | 8.39 |
| 4 | −69.553 | 1.72 | | | 8.48 |
| 5 | −13.025 | 1.96 | 1.94594 | 18.0 | 8.57 |
| 6 | −9.329 | (Variable) | | | 9.13 |
| 7 | 10.819 | 1.43 | 2.00100 | 29.1 | 5.92 |
| 8 | 8.522 | 1.80 | | | 5.64 |
| 9 | 11.175 | 2.97 | 1.59270 | 35.3 | 6.24 |
| 10 | −45.024 | 1.81 | | | 6.21 |
| 11 (SP) | ∞ | 4.67 | | | 6.01 |
| 12 | 104.209 | 0.80 | 2.10420 | 17.0 | 5.54 |
| 13 | 19.269 | 2.05 | 1.43700 | 95.1 | 5.46 |
| 14 | −24.364 | 2.00 | | | 5.50 |
| 15 | 30.202 | 2.17 | 1.59270 | 35.3 | 5.85 |
| 16 | −34.028 | (Variable) | | | 6.24 |
| 17 | 20.373 | 3.00 | 1.51742 | 52.4 | 6.56 |
| 18 | −10.968 | 0.80 | 1.95375 | 32.3 | 6.64 |
| 19 | −55.363 | (Variable) | | | 6.85 |
| Image Plane | ∞ | | | | |

VARIOUS DATA

| ZOOM RATIO 1.79 | | | WIDE | | TELE |
|---|---|---|---|---|---|
| Focal Length | | | 5.94 | | 10.64 |
| Fno | | | 3.50 | | 5.03 |
| Half Angle of View (°) | | | 39.22 | | 24.51 |
| Image Height | | | 4.85 | | 4.85 |
| Overall Lens Length | | | 58.44 | | 58.44 |
| BF | | | 13.92 | | 13.92 |
| d6 | | | 12.29 | | 2.00 |
| d16 | | | 1.00 | | 11.29 |
| d19 | | | 13.92 | | 13.92 |
| Entrance Pupil Position | | | 6.02 | | 5.23 |
| Exit Pupil Position | | | −17.90 | | −29.25 |
| Front Principal-Point Position | | | 10.86 | | 13.25 |
| Rear Principal-Point Position | | | 7.98 | | 3.29 |
| LENS UNIT DATA | | | | | |
| Lens | Starting | Focal | Lens Configuration | Front Principal- | Rear Principal- |
| Unit | Surface | Length | Length | Point Position | Point Position |
| 1 | 1 | −8.85 | 7.72 | −0.74 | −8.99 |
| 2 | 7 | 17.44 | 19.72 | 10.63 | −10.72 |
| 3 | 17 | 246.22 | 3.80 | −9.09 | −11.09 |

### Numerical Example 3

UNIT: mm
SURFACE DATA

| Surface No. | r | d | nd | vd | Effective Diameter |
|---|---|---|---|---|---|
| 1* | 23.045 | 0.80 | 1.98525 | 31.5 | 13.89 |
| 2* | 7.577 | 4.03 | | | 11.04 |
| 3 | −65.410 | 0.80 | 1.89043 | 41.6 | 9.90 |
| 4 | 19.704 | 1.00 | | | 9.43 |
| 5 | −46.534 | 0.40 | 1.83835 | 46.0 | 9.40 |
| 6 | 22.127 | 0.80 | | | 9.42 |
| 7 | 20.289 | 2.73 | 1.93381 | 22.8 | 9.79 |
| 8 | −39.413 | (Variable) | | | 9.72 |
| 9 | 9.935 | 1.40 | 2.00100 | 29.1 | 5.84 |
| 10 | 7.673 | 1.87 | | | 5.52 |
| 11 | 10.635 | 6.02 | 1.59270 | 35.3 | 6.18 |
| 12 | −40.659 | 1.80 | | | 6.13 |
| 13 (SP) | ∞ | 2.15 | | | 5.93 |
| 14 | 11.820 | 0.80 | 2.10420 | 17.0 | 5.67 |
| 15 | 7.376 | 2.24 | 1.43700 | 95.1 | 5.37 |
| 16 | 34.003 | 2.00 | | | 5.20 |
| 17 | 58.113 | 2.06 | 1.59270 | 35.3 | 5.07 |
| 18 | −19.830 | (Variable) | | | 4.97 |
| 19 | −30.177 | 2.37 | 1.51742 | 52.4 | 6.06 |
| 20 | −8.448 | 0.80 | 1.95375 | 32.3 | 6.50 |
| 21 | −12.176 | 0.50 | | | 6.86 |
| 22* | −27.244 | 1.00 | 1.53500 | 55.7 | 6.97 |
| 23* | −34.502 | (Variable) | | | 7.21 |
| Image Plane | ∞ | | | | |

ASPHERIC DATA
1st Surface
K = 0.00000e+00 A 4 = −4.06825e−05 A 6 = 4.08773e−07 A 8 = 1.27474e−08
A10 = −2.37008e−10 A12= 1.16807e−12
2nd Surface
K = 0.00000e+00 A 4 = −4.63543e−05 A 6 = −9.53334e−07 A 8 = 4.74624e−08
A10 = −2.79488e−10 A12 = 8.76211e−12
22nd Surface
K = −1.83630e+01 A 4 = −8.07042e−04 A 6 = 6.31020e−05 A 8 = −4.51889e−06
A10 = 1.23665e−07
23rd Surface
K = −8.11192e+01 A 4 = −9.36175e−04 A 6 = 6.56446e−05 A 8 = −4.10436e−06
A10 = 1.02110e−07
VARIOUS DATA

| ZOOM RATIO 2.00 | WIDE | TELE |
|---|---|---|
| Focal Length | 5.42 | 10.83 |
| Fno | 3.50 | 5.67 |
| Half Angle of View (°) | 41.85 | 24.13 |
| Image Height | 4.85 | 4.85 |
| Overall Lens Length | 64.22 | 64.22 |
| BF | 13.99 | 13.99 |
| d8 | 13.67 | 2.00 |
| d18 | 1.00 | 12.67 |
| d23 | 13.99 | 13.99 |
| Entrance Pupil Position | 7.38 | 6.71 |
| Exit Pupil Position | −16.98 | −35.79 |
| Front Principal-Point Position | 11.84 | 15.18 |
| Rear Principal-Point Position | 8.57 | 3.16 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −8.15 | 10.56 | 0.87 | −8.31 |
| 2 | 9 | 16.50 | 20.34 | 9.71 | −10.11 |
| 3 | 19 | 121.24 | 4.67 | 9.20 | 6.61 |

### Numerical Example 4

UNIT: mm
SURFACE DATA

| Surface No. | r | d | nd | vd | Effective Diameter |
|---|---|---|---|---|---|
| 1 | 19.037 | 0.80 | 2.09651 | 18.7 | 10.03 |
| 2 | 8.243 | 2.23 | | | 8.88 |
| 3 | −21.227 | 0.40 | 1.89494 | 41.3 | 8.71 |
| 4 | 22.463 | 0.87 | | | 8.73 |
| 5 | 26.548 | 2.26 | 2.11847 | 16.8 | 9.06 |
| 6 | −51.967 | (Variable) | | | 9.07 |
| 7 | 11.681 | 1.39 | 2.00100 | 29.1 | 8.17 |
| 8 | 9.717 | 1.90 | | | 7.79 |
| 9 | 12.462 | 3.39 | 1.59270 | 35.3 | 8.46 |
| 10 | −58.141 | 1.77 | | | 8.33 |
| 11 (SP) | ∞ | 2.67 | | | 8.02 |
| 12 | 11.990 | 0.80 | 2.10420 | 17.0 | 7.48 |
| 13 | 7.781 | 2.77 | 1.43700 | 95.1 | 7.04 |
| 14 | 31.156 | 2.00 | | | 6.70 |
| 15 | 68.856 | 2.33 | 1.59270 | 35.3 | 6.45 |
| 16 | −22.043 | (Variable) | | | 6.21 |
| 17 | −9.207 | 2.00 | 1.51742 | 52.4 | 5.73 |
| 18 | −7.284 | 0.80 | 1.95375 | 32.3 | 6.23 |
| 19 | −9.267 | (Variable) | | | 6.62 |
| Image Plane | ∞ | | | | |

VARIOUS DATA

| ZOOM RATIO 2.50 | | WIDE | TELE |
|---|---|---|---|
| Focal Length | | 9.53 | 23.82 |
| Fno | | 3.50 | 5.66 |
| Half Angle of View (°) | | 26.97 | 11.51 |
| Image Height | | 4.85 | 4.85 |
| Overall Lens Length | | 68.05 | 68.05 |
| BF | | 19.91 | 19.91 |
| d6 | | 18.23 | 2.00 |
| d16 | | 1.54 | 17.77 |
| d19 | | 19.91 | 19.91 |
| Entrance Pupil Position | 8.83 | 6.77 | |
| Exit Pupil Position | −16.37 | −32.66 | |
| Front Principal-Point Position | | 15.86 | 19.80 |
| Rear Principal-Point Position | | 10.38 | −3.91 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −12.34 | 6.56 | −0.02 | −5.29 |
| 2 | 7 | 17.11 | 19.01 | 8.31 | −10.32 |
| 3 | 17 | −203.44 | 2.80 | −20.78 | −25.11 |

### Numerical Example 5

UNIT: mm
SURFACE DATA

| Surface No. | r | d | nd | vd | Effective Diameter |
|---|---|---|---|---|---|
| 1 | 15.607 | 0.80 | 2.21347 | 22.2 | 11.11 |
| 2 | 5.580 | 3.07 | | | 8.45 |
| 3 | −24.605 | 0.40 | 2.04882 | 33.2 | 7.74 |
| 4 | 15.976 | 3.05 | | | 7.50 |
| 5 | 21.517 | 2.12 | 1.95179 | 17.2 | 7.71 |
| 6 | −64.252 | (Variable) | | | 7.47 |
| 7 | 12.816 | 1.40 | 2.00100 | 29.1 | 5.10 |
| 8 | 8.513 | 1.92 | | | 4.94 |
| 9 | 15.713 | 3.14 | 1.59270 | 35.3 | 5.69 |
| 10 | −13.106 | 1.38 | | | 5.97 |
| 11 (SP) | ∞ | 7.21 | | | 5.80 |
| 12 | 19.556 | 0.80 | 2.10420 | 17.0 | 5.09 |
| 13 | 9.487 | 2.67 | 1.43700 | 95.1 | 4.91 |
| 14 | −21.597 | 2.00 | | | 5.63 |
| 15 | −36.957 | 2.00 | 1.59270 | 35.3 | 6.50 |
| 16 | −15.473 | (Variable) | | | 7.07 |
| 17 | −25.129 | 3.27 | 1.51742 | 52.4 | 7.35 |
| 18 | −7.141 | 0.80 | 1.95375 | 32.3 | 7.97 |
| 19 | −10.042 | (Variable) | | | 8.50 |
| Image Plane | ∞ | | | | |

VARIOUS DATA

| ZOOM RATIO 1.49 | WIDE | TELE |
|---|---|---|
| Focal Length | 4.62 | 6.89 |
| Fno | 3.50 | 4.48 |
| Half Angle of View (°) | 46.40 | 35.16 |
| Image Height | 4.85 | 4.85 |
| Overall Lens Length | 59.54 | 59.55 |
| BF | 13.71 | 13.71 |
| d6 | 8.80 | 2.00 |
| d16 | 1.00 | 7.81 |
| d19 | 13.71 | 13.71 |
| Entrance Pupil Position | 5.17 | 4.77 |
| Exit Pupil Position | −52.79 | −90.27 |
| Front Principal-Point Position | 9.46 | 11.21 |
| Rear Principal-Point Position | 9.09 | 6.83 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −6.78 | 9.44 | −0.17 | −10.10 |
| 2 | 7 | 16.92 | 22.53 | 11.89 | −12.08 |
| 3 | 17 | 55.37 | 4.07 | 6.48 | 4.37 |

### Numerical Example 6

UNIT: mm
SURFACE DATA

| Surface No. | r | d | nd | vd | Effective Diameter |
|---|---|---|---|---|---|
| 1 | 124.377 | 0.77 | 1.80440 | 39.6 | 10.74 |
| 2 | 11.810 | 1.24 | | | 9.64 |
| 3 | 414.494 | 0.37 | 1.60562 | 43.7 | 9.54 |
| 4 | 10.989 | 0.82 | | | 9.14 |
| 5 | 10.309 | 1.72 | 1.80000 | 29.8 | 9.21 |
| 6 | 12.970 | (Variable) | | | 8.67 |
| 7 | 94.558 | 0.59 | 1.91082 | 35.2 | 7.06 |
| 8 | 7.994 | 3.72 | 1.80100 | 35.0 | 6.91 |
| 9 | −27.238 | 1.24 | | | 6.86 |
| 10 | ∞ | 13.40 | 1.51633 | 64.1 | 10.78 |
| 11 | ∞ | 0.99 | | | 7.83 |
| 12 (SP) | ∞ | 0.99 | | | 8.03 |
| 13 | 32.318 | 0.79 | 2.00069 | 25.5 | 8.15 |
| 14 | 21.444 | 0.00 | 1.49700 | 81.5 | 8.09 |
| 15 | 21.444 | 2.89 | 1.49700 | 81.5 | 8.09 |
| 16 | −16.882 | 2.00 | | | 8.14 |
| 17 | ∞ | 13.40 | 1.51633 | 64.1 | 8.51 |
| 18 | ∞ | 2.00 | | | 12.24 |
| 19 | 37.036 | 2.00 | 1.88300 | 40.8 | 7.46 |
| 20 | 577.027 | (Variable) | | | 7.51 |
| 21 | 35.011 | 2.52 | 1.49700 | 81.5 | 7.59 |
| 22 | −15.682 | 0.80 | 2.00069 | 25.5 | 7.54 |
| 23 | −160.018 | (Variable) | | | 7.66 |
| Image Plane | ∞ | | | | |

VARIOUS DATA

| ZOOM RATIO 1.49 | WIDE | TELE |
|---|---|---|
| Focal Length | 9.03 | 13.48 |
| Fno | 3.54 | 4.30 |
| Half Angle of View (°) | 28.24 | 19.79 |
| Image Height | 4.85 | 4.85 |
| Overall Lens Length | 78.34 | 78.34 |
| BF | 13.52 | 13.52 |
| d6 | 11.57 | 3.37 |
| d20 | 1.00 | 9.20 |
| d23 | 13.52 | 13.52 |
| Entrance Pupil Position | 8.81 | 8.23 |
| Exit Pupil Position | −22.00 | −26.21 |
| Front Principal-Point Position | 15.54 | 17.13 |
| Rear Principal-Point Position | 4.49 | 0.05 |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −9.75 | 4.92 | 1.38 | −2.06 |
| 2 | 7 | 20.35 | 44.01 | 21.83 | −21.71 |
| 3 | 21 | −90.85 | 3.32 | 3.72 | 1.55 |

TABLE 1

| | NUMERICAL EXAMPLE | | | | | |
|---|---|---|---|---|---|---|
| Inequality | 1 | 2 | 3 | 4 | 5 | 6 |
| (1) Din/ft | 0.877 | 1.110 | 1.478 | 0.495 | 1.714 | 4.452 |
| (2) Din/fw | 1.316 | 1.985 | 2.955 | 1.238 | 2.555 | 6.644 |
| (3) TL/ft | 4.627 | 5.495 | 5.931 | 2.857 | 8.646 | 5.812 |
| 4) TL/fw | 6.940 | 9.833 | 11.860 | 7.138 | 12.890 | 8.675 |
| (5) f1/fw | −1.043 | −1.489 | −1.506 | −1.294 | −1.467 | −1.080 |
| (6) f2/fw | 2.060 | 2.934 | 3.047 | 1.795 | 3.664 | 2.253 |
| (7) fw/f3 | −0.104 | 0.024 | 0.045 | −0.047 | 0.083 | −0.099 |
| (8) Pe/fw | 4.480 | 5.354 | 5.719 | 3.806 | 14.397 | 3.933 |
| (9) PeT/ft | 3.251 | 4.059 | 4.597 | 2.207 | 15.100 | 2.948 |
| 10) f2/ft | 1.374 | 1.640 | 1.524 | 0.718 | 2.457 | 1.510 |
| 11) D2/ft | 0.561 | 1.062 | 1.170 | 0.700 | 1.132 | 0.785 |
| 12) Lb/fb | 1.144 | 1.065 | 1.332 | 0.741 | 1.151 | 1.648 |
| (13) TOL/fw | 5.244 | 7.491 | 9.277 | 5.050 | 9.922 | 7.178 |
| (14) Bt/ft | 1.131 | 1.309 | 1.292 | 0.836 | 1.991 | 1.003 |

### Image Pickup Apparatus

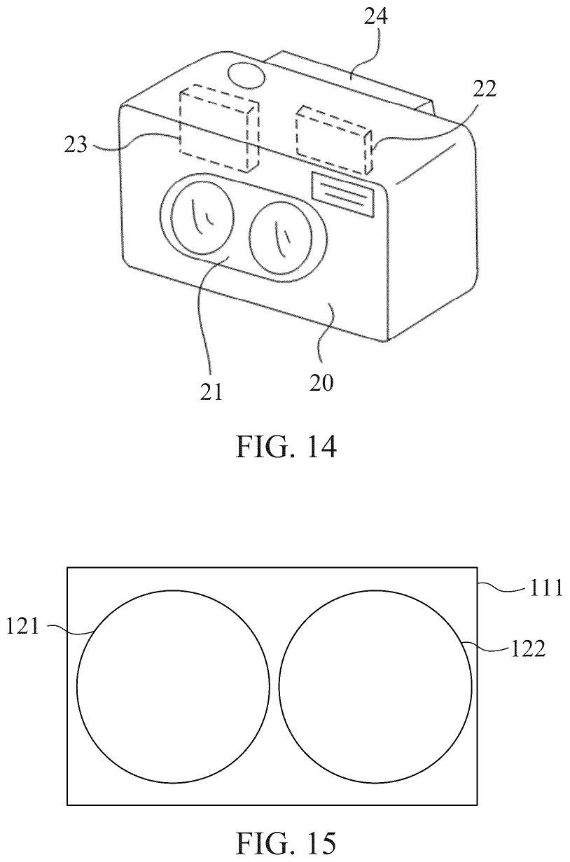

FIG. 14 illustrates a digital still camera as an image pickup apparatus that uses the stereoscopic optical system according to any one of the above examples as an imaging optical system. Reference numeral 20 denotes a camera body, reference numeral 21 denotes the imaging optical system including any one of the stereoscopic optical systems according to Examples 1 to 6, and integrated with the camera body 20. Reference numeral 22 denotes an image sensor such as a CCD sensor or CMOS sensor that is built into the camera body 20 and configured to capture an optical image (object image) formed by the imaging optical system 21. Reference numeral 23 denotes a recorder configured to record image data generated by processing an imaging signal from the image sensor 22, and reference numeral 24 denotes a rear display configured to display the image data.

Using the stereoscopic optical system according to each example can provide an image pickup apparatus that has a reduced size, a variable focal length, and excellent three-dimensional imageability. The image pickup apparatus may be a digital video camera, a digital still camera, a broadcasting camera, a surveillance camera, a film-based camera, or the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide a stereoscopic optical system in which an error in a variable focal length between two optical systems can be easily suppressed.

This application claims priority to Japanese Patent Application No. 2023-163021, which was filed on Sep. 26, 2023, and which is hereby incorporated by reference herein in its entirety.

What is claimed is:

1. A stereoscopic optical system comprising:
two optical systems arranged in parallel,
wherein optical images corresponding to the two optical systems are formed on different areas in a single image sensor,
wherein each of the two optical systems includes a plurality of lens units,
wherein a distance between adjacent lens units changes when a focal length changes in each of the two optical systems,
wherein one of the plurality of lens units is a movable lens unit,
wherein a focal length is changed by moving the movable lens unit, and
wherein the following inequality is satisfied:
$$0.5 \leq Din / fw \leq 50.0$$
where Din is a distance between optical axes of lenses closest to an object in the two optical systems, and fw is a focal length of each of the two optical systems at a wide-angle end.

2. The stereoscopic optical system according to claim 1, wherein each of the two optical systems includes, in order from an object side to an image side, a first lens unit, a second lens unit, and a third lens unit, and
wherein in changing the focal length, the first lens unit and the third lens unit do not move, but the second lens unit moves as the movable lens unit.

3. The stereoscopic optical system according to claim 2, wherein the first lens unit has negative refractive power, the second lens unit has positive refractive power, and the third lens unit has positive or negative refractive power.

4. The stereoscopic optical system according to claim 1, further comprising a structure configured to integrally move movable lens units in the two optical systems.

5. The stereoscopic optical system according to claim 1, wherein the following inequality is satisfied:
0.3≤Din/ft≤30.0
where ft is a focal length of each of the two optical systems at a telephoto end.

6. The stereoscopic optical system according to claim 1, wherein the following inequality is satisfied:
$$2. \leq TL / ft \leq 20.$$
where TL is a distance on an optical axis from a lens surface closest to the object in each of the two optical systems to an image plane, and ft is a focal length of each of the two optical systems at a telephoto end.

7. The stereoscopic optical system according to claim 1, wherein the following inequality is satisfied:
$$3. 0 \leq TL / fw \leq 50.0$$
where TL is a distance on an optical axis from a lens surface closest to the object in each of the two optical systems to an image plane.

8. The stereoscopic optical system according to claim 3, wherein the following inequality is satisfied:
$$- 5. \leq f 1 / fw \leq - 0.5$$
where f1 is a focal length of the first lens unit.

9. The stereoscopic optical system according to claim 3, wherein the following inequality is satisfied:
$$0.5 \leq f 2 / fw \leq 10.$$
where f2 is the focal length of the second lens unit.

10. The stereoscopic optical system according to claim 3, wherein the third lens unit has negative refractive power, and the following inequality is satisfied:
$$- 0.5 \leq fw / f 3 \leq 0.2$$
where f3 is a focal length of the third lens unit.

11. The stereoscopic optical system according to claim 3, wherein the first lens unit includes, in order from the object side to the image side, a first lens having negative refractive power and a second lens having negative refractive power.

12. The stereoscopic optical system according to claim 1, wherein the movable lens unit includes an aperture stop.

13. The stereoscopic optical system according to claim 1, further comprising a structure configured to entirely move each of the two optical systems for focusing, and to integrally move the two optical systems.

14. The stereoscopic optical system according to claim 1, wherein the
$$2. \leq PeW / fw \leq 50.0$$
where PeW is an exit pupil distance of each of the two optical systems at a wide-angle end.

15. The stereoscopic optical system according to claim 1, wherein the following inequality is satisfied:
$$2. \leq PeT / ft \leq 50.$$
where PeT is an exit pupil distance at a telephoto end of each of the two optical systems, and ft is a focal length of each of the two optical systems at the telephoto end.

16. The stereoscopic optical system according to claim 1, wherein the following inequality is satisfied:
$$0. 2 \leq fm / ft \leq 5.$$
where fm is a focal length of the movable lens unit, and ft is a focal length of each of the two optical systems at a telephoto end.

17. The stereoscopic optical system according to claim 1, wherein the following inequality is satisfied in a case where a moving amount is set positive when the movable lens unit is closer to the object at a telephoto end than at the wide-angle end in each of the two optical systems:
$$0 < Dm / ft \leq 5.$$
where Dm is the moving amount of the movable lens unit, and ft is a focal length of each of the two optical systems at the telephoto end.

18. The stereoscopic optical system according to claim 1, wherein the two optical systems each include an aperture stop, and the following inequality is satisfied:
$$0. 2 \leq Lb / fb \leq 10.0$$
where Lb is a distance from the aperture stop at the wide-angle end to an image plane in each of the two optical systems, and fb is a combined focal length of a portion on an image side of the aperture stop at the wide-angle end.

19. The stereoscopic optical system according to claim 1, wherein the following inequality is satisfied:
$$2. \leq TDL / fw \leq 50.0$$
where TDL is a distance on an optical axis from a lens surface closest to the object to a lens surface closest to an image plane in each of the two optical systems.

20. The stereoscopic optical system according to claim 1, wherein the following inequality is satisfied:
$$0. 2 \leq BF / fw \leq 5.$$
where BF is a back focus at the wide-angle end of each of the two optical systems.

21. An image pickup apparatus comprising:
a stereoscopic optical system; and
a single image sensor configured to perform imaging of an object through the stereoscopic optical system,
wherein the stereoscopic optical system includes two optical systems arranged in parallel,
wherein optical images corresponding to the two optical systems are formed on different areas in a single image sensor,
wherein each of the two optical systems includes a plurality of lens units,
wherein a distance between adjacent lens units changes when a focal length changes in each of the two optical systems,
wherein one of the plurality of lens units is a movable lens unit,
wherein a focal length is changed by moving the movable lens unit, and
wherein the following inequality is satisfied:
$$0.5 \leq Din / fw \leq 50.$$
where Din is a distance between optical axes of lenses closest to an object in the two optical systems, and fw is a focal length of each of the two optical systems at a wide-angle end.
